(19) United States
(12) Patent Application Publication
(10) Pub. No.: US 2008/0067124 A1
(43) Pub. Date: Mar. 20, 2008

(54) Solvent recovery system for plastic dying operation

(76) Inventors: Edward F. Kaczkowski, Pittsburgh, PA (US); Daniel E. Jaskiewicz, Dawson, PA (US); Rick L. Archey, Pleasant Hills, PA (US); George See, Venetia, PA (US); Robert A. Pyles, Bethel Park, PA (US)

Correspondence Address: BAYER MATERIAL SCIENCE LLC, 100 BAYER ROAD, PITTSBURGH, PA, 15205, US

(21) Appl. No.: 11/523,315

(22) Filed: Sep. 19, 2006

(51) Int. Cl. B01D 11/04

(52) U.S. Cl. 210/634; 210/691

(57) ABSTRACT

An apparatus for recovering components of a material system containing dye, water, and solvents such as ethylene glycol monobutyl ether and diethylene glycol is provided. The apparatus comprises in sequence: a first vessel including a cooling device for cooling the material system; a pump; at least one first filter; at least one purifying vessel containing activated carbon; optionally, a second filter; and a second vessel optionally including a probe. Each of the first vessel, purifying vessel, filter housings and baskets, second vessel and interconnecting piping are fabricated of a material which does not absorb dye, such as stainless steel.

### FIELD OF THE INVENTION

The present invention relates to an apparatus for removal of dye from materials used in plastic dying operations.

### BACKGROUND INFORMATION

In the course of dying plastic materials by immersing them in a bath it is sometimes desired to change the compositional makeup of the bath, such as for making it useable for a different tint, or for rinsing the dyed articles to remove residual surface dye. In these instances, it is more economical and environmentally desirable to re-use the solvent. Without such a recovery system, spent solution must be incinerated or disposed of in landfills.

U.S. Pat. No. 6,994,735 describes a method of purifying dye solutions to obtain a clean, dye-free solvent by passing the dye solution through activated carbon. No apparatus for performing such operations is described.

JP10005750 describes removal of a dye in a dyeing waste liquor by the use of a dye removing agent by sticking a powdery or particulate siliceous stone on a surface of a carbonized carbonaceous material. The siliceous material is silicic anhydride, aluminum oxide, magnesium oxide, or calcium oxide.

JP1279978 describes improving solubility to thereby reduce the toxicity of Solvent Black 3 by dissolving it in a specified aromatic or petroleum-base hydrocarbon and removing insoluble matter by filtration. If the filtrate, after removing insoluble matter therefrom, is treated with an absorbent such as activated carbon, dissolved polar substances are removed so that low toxicity is assured.

It would be desirable to have an efficient apparatus for continuous dye removal during plastic dying operations.

### SUMMARY OF THE INVENTION

Accordingly, the present invention provides an apparatus for recovering components of a material system containing dye, water, and solvents such as ethylene glycol monobutyl ether and diethylene glycol, comprising in sequence: a first vessel including a cooling device for cooling the material system; a pump; at least one first filter; at least one purifying vessel containing activated carbon; optionally, a second filter; and a second vessel optionally including a probe.

These and other aspects of the present invention will become more readily apparent from the following drawing, detailed description and appended claims.

### BRIEF DESCRIPTION OF THE DRAWINGS

The invention is further illustrated by the following drawings in which:

FIG. 1 is an apparatus according to an embodiment of the present invention.

### DETAILED DESCRIPTION OF PREFERRED EMBODIMENTS

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The present invention provides an apparatus for removal of dye from solutions used in plastic dying operations. Dyes used in such operations include, for example, conventional dyes such as fabric dyes and disperse dyes as well as dyes that are known in the art as suitable for tinting of polycarbonates. Examples of suitable disperse dyes include Disperse Blue #3, Disperse Blue #14, Disperse Yellow #3, Disperse Red #13 and Disperse Red #17. Dyestuffs are generally used either as a sole dye constituent or as a component of a dye mixture depending upon the color desired. Thus, the term “dye” as used herein includes “dye mixture”. Solvent dyes are also used in plastic dying operations, some examples of which include Solvent Blue 35, Solvent Green 3 and Acridine Orange Base. Also used are water-insoluble azo, diphenylamine and anthraquinone compounds; acetate dyes, dispersed acetate dyes, dispersion dyes and dispersol dyes, specific examples of which include Dystar's Palanil Blue E-R150 (anthraquinone/Disperse Blue) and DIANIX Orange E-3RN (azo dye/Cl Disperse Orange 25). Acid dyes, such as those used for dying nylon, as well as reactive dyes sold under the trade name Reactint for use with polyurethanes and polyurethane blends, are also embraced by the present invention. The apparatus of the present invention is suitable for removal of any organic dye from the solution used to color the plastic, as well as photochromic dyes, UV-stabilizers and other plastics performance enhancing additives.

Each of the first vessel, purifying vessel, filter housings and baskets, second vessel and interconnecting piping are fabricated of stainless steel, aluminum or plastic materials which do not absorb dyes from the solution. As used herein, the term “material which does not absorb dye from solution” will be used to denote any of these materials. Preferably, the components of the apparatus are made of stainless steel.

The dye solution typically contains organic solvents such as ethylene glycol butyl ether, diethylene glycol ethylether, diethylene glycol butylether, propylene glycol propylether, dipropylene glycol propylether and tripropylene glycol propylether and diethylene glycol.

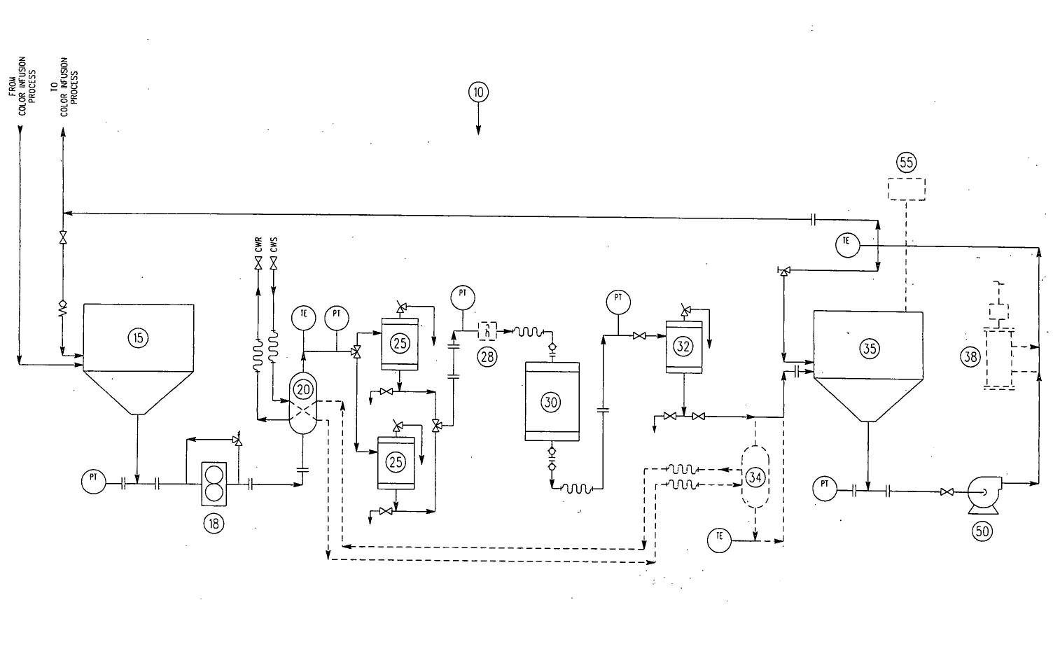

Referring now to FIG. 1, which illustrates an embodiment of an apparatus 10 of the present invention, spent solutions from the color infusion process are transferred by pumping, by gravity feed (if vessel 15 is at a lower level than the color infusion process), or other means (such as by bucket or similar device) to a first vessel 15. A pump 18 controls the flow rate through the apparatus, and a cooling device 20 lowers the temperature of the spent solution to a degree sufficient to precipitate at least some of the dye. Typically, the temperature will be lowered to somewhere between 25-90° C., more preferably 45-75° C. The incoming spent solution from the dying process is typically between 95° C. and 45° C. This temperature is dependent on the plastic material being colored. For example, rigid materials such as polycarbonate can be color infused above 90° C. while more flexible, rubbery materials can color around 45-60° C. The color infusion solution temperature is carefully controlled so that the dye concentrations are at saturation for the given color infusion temperature. Consequently, as soon as the temperature is reduced (either through natural heat loss over time or through the use of a heat exchanger which is much faster and more efficient than natural heat loss), the dyes will become less soluble and begin to precipitate. Eventually, so much dye precipitates that crystals begin to form. Some dyes, such as Reactints from Milliken, are water soluble liquids and remain in solution at room temperature. Hence, these dyes are not recovered in filter 25. The first vessel 15 can be made of stainless steel, aluminum or plastic material(s) that do not absorb significant amount of dye from the treated solution. In a preferred embodiment, the first vessel 15 is made of stainless steel.

The cooled spent solution is pumped out of the first vessel 15 through a first filter 25 positioned between the first vessel 15 and the activated carbon contained in a purifying vessel 30. Optionally, and as shown in FIG. 1, two first filters in parallel can be used. The first filter 25 removes the dye precipitated by cooling the spent solution. The first filter 25 includes pores that are sized at most 25 microns. Although smaller filter bags with a 5 micron pore size can be used, the 25 micron bags are preferred because the dye crystals can be captured but yet there is not a significant pressure increase caused by the bag alone. Preferably, the bag filter housing and basket are constructed of stainless steel, and the bag is nylon.

The spent solution passes through the first filter 25 to the purifying vessel 30 containing the activated carbon. Optionally the system is equipped with a flow meter 28 to measure the volume of spent dye solution treated, to indicate the efficacy of the activated carbon. The flow meter 28 measures the actual flow rate into the purifying vessel. There is also an optional accumulator (not shown) associated with the flow meter to determine the total quantity of solution that has passed through the purifying vessel 30. It is estimated that the purifying vessel 30 will need to be removed and regenerated after approximately 25,000-27,000 gallons of spent solution has been purified.

The activated carbon removes the remaining dye from the spent solution. The purifying vessel 30 is preferably constructed of stainless steel, as in a stainless steel drum. The spent solution is pumped through the activated carbon at a rate sufficient to remove dye from the solvent, preferably 1 to 2 gal/minutes. If the spent solution is pumped too fast, some dye will remain in the “clean” solution and make the solution unfit for formulating new colors in the color infusion apparatus. If the spent solution is pumped too slowly, then the process will not produce enough clean solvent in time to rinse parts in the color infusion apparatus, formulate new color infusion solutions and for washing. Also, a slower rate is not economical. Optionally the spent solution can enter vessel 30 either from the top or from the bottom. However, the preferred point of entry is from the bottom of vessel 30 (not shown) to prevent channeling of the liquid through the carbon particles, creating inefficient absorption of the dye. Optionally the system contains two or more purifying vessels containing activated carbon arranged in parallel (not shown), to enable removal of depleted activated carbon without stopping the recovery process.

The cleaned solution is pumped from the purifying vessel 30 to a second vessel 35. Optionally, a second filter 32 is included between the purifying vessel 30 and the second vessel 35. The second filter 32 serves to remove fugitive activated carbon particles from the clean solvent stream. Preferably, the second filter 32 is constructed from stainless steel.

The second vessel 35 is a holding tank for the “clean” solution. Heated solvent can be used for rinsing color infused parts and formulating new colors in the color infusion apparatus, and therefore the second tank 35 can be optionally provided with a heat exchanger 34, positioned after the activated carbon and before the second vessel 35. The heat exchanger 34 transfers the heat from the hot dye solution entering the first vessel 15 to the clean solution entering the second vessel 35 as a means of heating the clean solution. Preferably, the second vessel 35 is constructed of stainless steel. Also optionally, a heater 38 can be positioned after the second vessel. A second pump is optionally 50 is included after the second vessel 35, to pump clean solvent to the dye formulation tank or alternatively, to rinse colored articles free of residual surface dye or alternatively, to return any off-specification or contaminated solution to the first vessel for reprocessing.

Preferably, the system contains an in-line probe 55 or detector in the clean solvent line to determine the clean solvent composition. The probe can be a near IR analyzer or other instrument for determining purity. Other analytical techniques for determining the clean solvent composition, such as gas chromatography, can be used, but near IR (NIR) is the most reliable and cost effective means to do this analysis.

Whereas particular embodiments of this invention have been described above for purposes of illustration, it will be evident to those skilled in the art that numerous variations of the details of the present invention may be made without departing from the invention as defined in the appended claims.

What is claimed is:

1. An apparatus for recovering components of a material system containing dye, water, and organic solvent, comprising in sequence
a first vessel including a device for cooling the material system;
a pump;
at least one first filter;
at least one purifying vessel containing activated carbon;
optionally, a second filter;
a second vessel, optionally including a probe;
each of said first vessel, purifying vessel and second vessel being fabricated of a material which does not absorb dye.

2. The apparatus of claim 1, wherein the first filter includes pores sized at most 25 microns.

3. The apparatus of claim 1, wherein the cooling device lowers the temperature of the material system by at least 20° C.

4. The apparatus of claim 1, wherein two or more purifying vessels are used and are arranged in parallel with one another.

5. The apparatus of claim 1, further including a flow meter.

6. The apparatus of claim 1, further including a heat exchanger.

7. The apparatus of claim 1, further including a second pump.

8. The apparatus of claim 1, wherein two or more first filters are used and are arranged in parallel with one another.

9. The apparatus of claim 1, wherein each of said first vessel, purifying vessel and second vessel being fabricated of stainless steel.
